(19) United States
(12) Patent Application Publication
(10) Pub. No.: US 2019/0172355 A1
(43) Pub. Date: Jun. 6, 2019

(54) CONTROL SYSTEM AND CONTROL METHOD FOR DRIVING A MOTOR VEHICLE AND FOR AVOIDING A COLLISION WITH ANOTHER MOTOR VEHICLE

(71) Applicant: Lucas Automotive GmbH, Koblenz (DE)

(72) Inventors: Nico Stock, Koblenz (DE); Tim Schwickart, Morbach-Merscheid (DE)

(21) Appl. No.: 16/197,423

(22) Filed: Nov. 21, 2018

(30) Foreign Application Priority Data
Dec. 1, 2017 (DE) 10 2017 011 140.5

(51) Int. Cl. G08G 1/16; B60W 30/16; G05D 1/02

(52) U.S. Cl. CPC G08G 1/167; B60W 30/162; B60W 2550/308; G05D 1/0223; G08G 1/166

(57) ABSTRACT

A system and a method for use in an own motor vehicle to identify, on the basis of environmental data, motor vehicles driving in front, next to and/or behind an own motor vehicle and preferably objects standing in front, to provide the environmental data representing an area in front of, next to and/or behind the own motor vehicle, and which comprises:
detecting another motor vehicle participating in traffic in front of the own motor vehicle as reference vehicle relative to the own motor vehicle both on a lane on which the own motor vehicle is also travelling and on a neighbouring lane with slower traffic than the own motor vehicle,
starting out from a momentary location, determining the distance and the relative speed with respect to a vehicle driving in front in the slower neighbouring lane,
receiving a signal of a driver's desire for a lane change or a request signal for a lane change or for a merging manoeuvre,
determining whether a lane change is possible within predetermined limits from the distance and the relative speed with respect to the vehicle driving in front in the slower neighbouring lane, and
if this is given, effecting a reduction in the driving speed of the own motor vehicle by a braking and/or engine management intervention, in order to enable the driver of the own motor vehicle to change lane to the slower lane.

### BACKGROUND TO THE INVENTION

A control system and a control method are disclosed here for avoiding a collision with a motor vehicle driving in front in the event of a lane change. This control system and control method are based in particular on an environmental sensor system in the own motor vehicle and support a driver or a self-driving motor vehicle. In the case of semi-autonomous motor vehicles and autonomously controlled motor vehicles they are intended to increase the safety of the occupants of the motor vehicle.

### PRIOR ART

Today's driver assistance systems (ADAS advanced driver assistance systems) offer a plurality of monitoring and hint functions in motor vehicles to make driving a motor vehicle safer. The environment of the motor vehicle is monitored with regard to the travel progression of the own motor vehicle based on environmental data obtained from one or more environmental sensor(s) located on the motor vehicle.

In so-called ACC systems (Adaptive Cruise Control), the speed of the own motor vehicle is adapted to the speed of a motor vehicle driving in front by an automatic speed adjustment. A specified distance to the motor vehicle driving in front is always to be maintained in this case. To this end, such systems determine a movement direction and/or a speed of the motor vehicle driving in front, in order to avoid the own motor vehicle crossing the path of the motor vehicle driving in front in such a way that a critical situation arises. This concerns lane changing or turning-off manoeuvres on the one hand and avoiding rear-end collisions on the other hand.

A cruise control system in a motor vehicle that adjusts the distance to a motor vehicle driving in front and an emergency brake assistant in a motor vehicle are driver assistance systems that react to other road users, for example other motor vehicles or pedestrians. For this the most relevant road user is selected to execute an appropriate action.

In motor vehicles driven by persons, the driving assistance systems mostly offer a hint or influencing function, in order to warn the driver of a critical situation or a corresponding manoeuvre or to propose a suitable manoeuvre for the own motor vehicle to the driver, or even to execute this intervention. The driving assistance systems can likewise be used even in autonomously controlled motor vehicles to provide the autonomous control system with the appropriate environmental data.

The support of a driver of a motor vehicle by control or driver assistance systems such as ACC, for example, contributes to the travel comfort and operational safety of (motor) vehicles. Control or driver assistance systems can detect external influences on the own driving situation and alert the driver to these influences by optical, acoustic or haptic signals. Due to this, the driver can recognise the influences on the own driving situation at an early stage and react appropriately. The travel comfort and safety of other road users can also be positively influenced indirectly by an early recognition of external influences on the driving situation and consequent appropriate reactions of the driver following this.

Active cruise control ACC identifies vehicles driving in front, determines their speeds and maintains a desired distance by braking and engine interventions. The driver can thus be unburdened, especially in the case of longer journeys and flagging concentration. The ACC system is based on a cruise controller. If the own motor vehicle draws level with a vehicle driving in front, the ACC system brakes the own vehicle automatically by engine and/or braking interventions and maintains a distance to the vehicle driving in front that is set by the driver. To do this, the relative speed between the own ACC vehicle and the vehicle driving in front is determined by means of radar. As soon as no vehicle driving in front is located any longer in the measuring range of the radar lobe, the ACC system accelerates the own vehicle again to a preselected speed. The driver selects the desired speed and the desired distance to vehicles driving in front via an operating unit in the cockpit. A display in the cockpit informs the driver of the operating state and the selected settings. In addition to the desired speed, the driver of the own vehicle selects the distance as a time interval, which is maintained relative to the vehicles driving in front.

The ACC system has a sensor-controller unit, which comprises the radar sensor and the ACC control apparatus. The detection range of modern ACC systems ranges from 0.5 to 250 metres with an aperture angle of the radar lobe of up to 30 degrees.

The radar sensor determines data from which distance and relative speed with respect to a vehicle driving in front are determined. The time remaining to a collision is determined from this. The sensors of the electronic stability program supply information about the direction of travel, in order to be able to select the vehicles relevant for the ACC control system. If the ACC system detects a slower vehicle driving in front in the own lane, it adapts the speed by way of interventions in the engine management and the braking system so that the own vehicle follows at the desired distance. The ACC system can detect even on bends which of the vehicles driving in front is significant for the cruise control of the own vehicle. If the own lane is free, the vehicle accelerates to the preselected speed. The ACC system is designed as a comfort system. The degree of acceleration and the braking intervention are deliberately limited. In conventional ACC systems the driver must also make decisions about steering manoeuvres or heavy braking operations by himself. The driver's desire always takes priority over the automatic control system.

### Underlying Problem

On roads with several lanes in one travel direction, a lane change by a motor vehicle can have fatal consequences if the behaviour of a motor vehicle driving in front in the own or the neighbouring lane is not estimated correctly, not recognised correctly or is recognised too late by a driver or a driver assistance system of the own motor vehicle when the own motor vehicle changes lane. This applies, for example, to a slowing down of the motor vehicle driving in front, on which the own motor vehicle changing to the neighbouring lane could “get caught”. This plays a role, for example, if the own motor vehicle changing to the neighbouring lane is changing from a “faster” lane to a “slower” lane (thus e.g. in continental Europe or the USA from the left-hand or middle lane to the middle or right-hand lane). For example, a high speed difference can prevail in Germany between a following motor vehicle in the “faster” lane and a motor vehicle driving in front in the “slower” lane. The own motor vehicle changing to the neighbouring lane must compensate for this speed difference by slowing down during the lane change, in order not to cause a rear-end collision with the vehicle driving in front in the neighbouring lane.

On account of such a speed difference, a misjudgement, incorrect or too late initiation of the lane change of the own motor vehicle, for example, can lead to a collision with the motor vehicle driving in front. Only hard braking or evasion, for example back into the “faster” lane, may still prevent a rear-end collision. For motor vehicles following the own motor vehicle, this can lead to otherwise unnecessary braking operations and/or critical driving manoeuvres of the following motor vehicle. Such unnecessary braking operations and/or driving manoeuvres can also endanger other road users and/or adversely affect driving comfort.

The solution proposed here is based on the technical object of providing a control system and a control method for a motor vehicle to guide the motor vehicle along a path and to avoid a collision with a motor vehicle driving in front during a lane change.

### Proposed Solution

This object is achieved by a control system and control method with the features of the respective independent claims. A system/a method supports the driver/the autonomous control of an own vehicle on a two- or multi-lane road in taking into account also motor vehicles on the slower adjacent lane ahead of the own motor vehicle. A control system that is adapted and intended for use in an own motor vehicle identifies vehicles driving in front and preferably objects standing in front on the basis of environmental data obtained from at least one environmental sensor associated with the own motor vehicle. Here the at least one environmental sensor is adapted to provide an electronic controller of the control system with environmental data representing an area in front of the own motor vehicle. The control system is at least adapted and intended, starting out from a momentary location, to determine the distance to and the relative speed with respect to a vehicle driving in front in the slower neighbouring lane. As soon as the control system recognises a driver's desire to change lane from a man-machine interface inside the vehicle or a request for a lane change or for a merging manoeuvre from the route output of a navigation system, the control system checks whether a lane change or merging manoeuvre is possible within predetermined jerk/deceleration limits without falling below a predetermined minimum distance to the vehicle driving in front in the slower neighbouring lane. As soon as this is given, a request for a reduction in the driving speed of the own motor vehicle is signalled to the control system, in order to enable the driver to change lane to the slower lane.

If the actual initiation of the lane change is detected via additional sensor information (such as steering angle, yaw rate, angle to lane, lateral position with respect to the vehicle driving in front or similar), the speed of the own motor vehicle is reduced to the extent that the desired distance to the vehicle driving in front in the slower (target) lane is safely set. The control system adjusts the distance/the differential speed between the own motor vehicle and the vehicle driving in front according to the situation optionally to the vehicle driving in front in the own or in the neighbouring lane. Here the relevant target vehicle (in the own or the neighbouring lane) can be displayed to the driver of the own motor vehicle by way of a suitable graphical representation via the man-machine interface of the own motor vehicle.

If no vehicle is located on the slower neighbouring lane in front of the own motor vehicle in the detection range of the environmental sensor, no deceleration of the own motor vehicle is initiated when changing lanes. Thus driving to suit the situation is enabled while the driver is effectively supported in the driving operation. Driver interventions in the ACC operation are reduced and the usefulness/added value of the adaptive cruise control/the control system are increased. Compared with conventional driver assistance systems, the solution proposed here improves low-risk execution of a lane change of the own motor vehicle relative to a motor vehicle driving in front. This low-risk execution of a lane change is achieved in particular by the control system being able and adapted to influence relevant factors of the lane change (differential speed, distance, etc.) favourably. The application of the system is thus not limited to “emergency situations”, but can be used in many situations.

As with conventional ACC systems, the decision regarding merging remains with the driver; but he receives in-depth decision assistance with respect to the current driving situation in his environment. Heavy braking operations/critical driving manoeuvres can be avoided in this way.

This permits an increase in driving safety and driving comfort in that, in a lane change of the own motor vehicle on account of another motor vehicle driving in front, possible problems are identified correctly and promptly and thus a speed adaptation and/or a driving manoeuvre of the own motor vehicle can be carried out either by the driver or a driver assistance system to avoid an accident.

The reduction in driver interventions in the speed profile of the own vehicle in favour of an automated speed/distance adaptation relative to the other motor vehicle driving in front, which adaptation is optimally adapted to the situation, increases driving safety in road traffic even in more complex driving situations.

It is obvious to the person skilled in the art that the aspects and features described above can be combined in any way in a control system and/or a control method. Although some of the features described above were described in regard to a control system, it is understood that these features can also apply to a control method. In just the same way, the features described above in regard to a control method can apply in a corresponding manner to a control system.

### BRIEF DESCRIPTION OF THE DRAWING

Other aims, features, advantages and application possibilities result from the following description of exemplary embodiments, which are not to be understood as restrictive, with reference to the drawing. Here all features described and/or depicted show by themselves or in any combination the object disclosed here. The dimensions and proportions of the components shown in the figures are not necessarily to scale here.

FIG. 1 shows schematically an own motor vehicle, in which the environmental situation in an area in front of the own motor vehicle is identified by means of a control system.

FIG. 2 shows a schematic block circuit diagram of the controller of the control system of the own motor vehicle from FIG. 1.

### DETAILED DESCRIPTION OF THE DRAWING

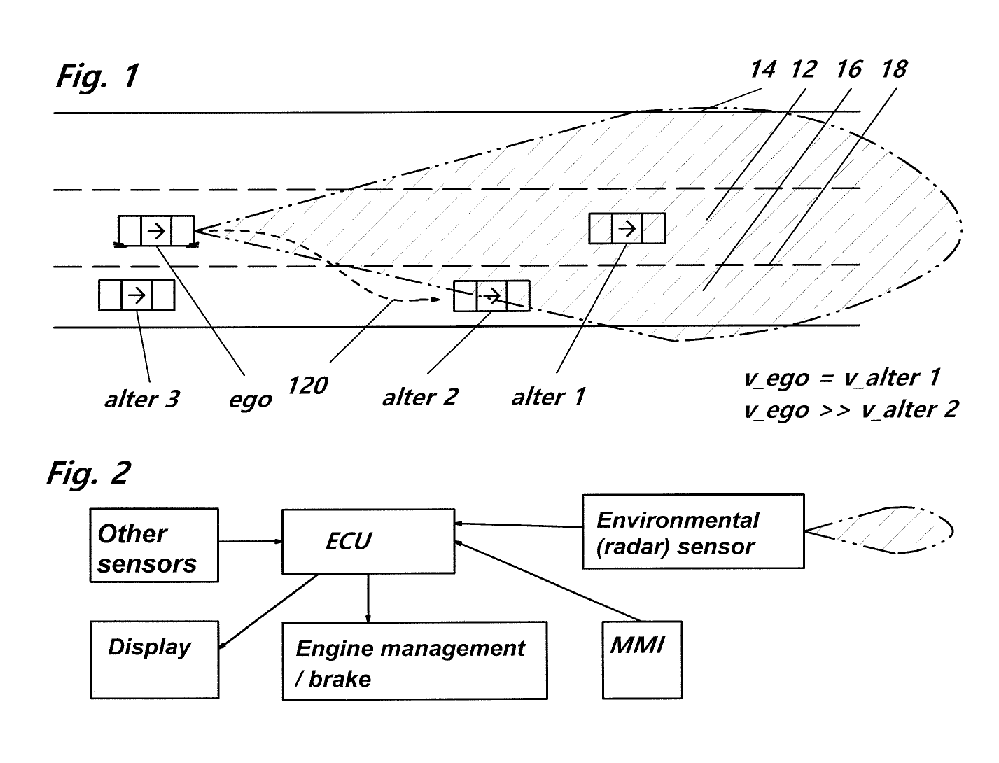

FIG. 1 shows schematically an own motor vehicle ego, which is located on the middle lane 12 of a road 14. Adjacent to the right-hand lane 12 is another, left-hand lane 16 of the road 14. The lanes of the road 14 are marked here by dashed road markings 18.

The own motor vehicle ego has at least one environmental sensor associated with the own motor vehicle and fitted on this, here in the form of a radar sensor. The environmental sensor can be formed in the form of a camera, for example, but also the use of other known environmental sensors (lidar, ultrasonic, or combinations of all of these sensors) is also possible. The at least one environmental sensor is adapted to identify an area in front of the own motor vehicle ego and to provide the environmental data representing this area to an electronic controller ECU of a control system installed in the own motor vehicle ego. In the example shown in FIG. 1, the control system recognises by means of the at least one environmental sensor a first other motor vehicle alter1, which is travelling at a lower speed (e.g. 135 km/h) than the own motor vehicle ego (e.g. 140 km/h) in the middle lane in front of the own motor vehicle ego. The first other motor vehicle alter1 is currently the reference vehicle for the ACC system implemented in the control system. Furthermore, the environmental sensor detects a second other motor vehicle alter2, which is travelling at a slower speed (e.g. 85 km/h) than the own motor vehicle ego in the right-hand, slow lane 12 in front of the own motor vehicle ego. In the driving situation illustrated in FIG. 1, there is located in the right-hand lane 12 next to the own motor vehicle ego a third other motor vehicle alter3, which is travelling at a similar speed (e.g. 85 km/h) to the second other motor vehicle alter2 in the right-hand, slow lane 12 behind the latter. The own motor vehicle ego must execute a lane change in the situation shown in FIG. 1 from the middle, faster lane along a trajectory 120 to the right-hand, slower lane 12.

The controller ECU of the control system detects to this end in front of the own motor vehicle ego from the environmental data of the environmental sensor another motor vehicle alter1, alter2, alter3 participating in traffic as reference vehicle relative to the own motor vehicle ego both on the lane on which the own motor vehicle ego is travelling and on the neighbouring lane with slower traffic than the own motor vehicle ego. Controller ECU of the control system determines for this, starting out from the momentary location of the own motor vehicle ego, the distance to and the relative speed with respect to the second vehicle alter2 driving in front in the slower neighbouring lane.

The controller ECU of the control system receives a signal from a man-machine interface MMI in the own motor vehicle ego of a driver's desire to change lane or a request signal from the route output of a navigation system for a lane change or a merging manoeuvre. The man-machine interface MMI in the own motor vehicle ego is an indicator switch in one variant. In another variant this is recognition of an eyelid/pupil/head position of the driver in the form of an internal camera directed at the head of the driver, the image data of which is evaluated to recognise the driver's desire for the lane change.

The controller ECU of the control system determines from the distance and the relative speed of the own motor vehicle ego with respect to the vehicle alter2 driving in front in the slower right-hand neighbouring lane whether a lane change is possible within predetermined limits. The predetermined limits in this case are a maximal deceleration of the own motor vehicle ego, e.g. 0.3 m/s, a minimal distance of the own motor vehicle ego to the vehicle driving in front in the slower lane, wherein this minimal distance can be selected as a function of the speed of the vehicle alter2 driving in front in the slower, right-hand neighbouring lane, and a minimal distance between the vehicle alter2 driving in front and a vehicle alter3 following this in the slower lane of, for example, five vehicle lengths of the own motor vehicle ego.

If this is given, the controller ECU of the control system effects a reduction in the driving speed of the own motor vehicle by a braking and/or engine management intervention. This intervention takes place with the proviso that the above limit values are aimed for and attained gradually, in order to enable the driver of the own motor vehicle ego to make the lane change to the slower lane.

The control system will recognise the actual initiation of the lane change to the slower lane in that other sensors in the own motor vehicle ego signal the actual initiation of the lane change to the slower lane by additional sensor information such as, for example, steering angle, yaw rate, angle to the lane, lateral position with respect to the vehicle driving in front. Starting out from the route of the trajectory 120 of the own motor vehicle ego from initiation of the lane change to the slower lane up to conclusion, the control system calculates here the degree of reduction in the driving speed of the own motor vehicle ego and executes the braking and/or engine management intervention in such a way that a predetermined distance to the vehicle alter2 driving in front on the slower lane is safely set and also a driving speed of the own motor vehicle ego adapted to the speed of the vehicle alter2 driving in front on the slower lane is attained.

The controller ECU of the control system selects, according to the situation, optionally the vehicle driving in front in the own or the neighbouring lane as reference vehicle. This means that before initiation of the lane change to the slower lane, the vehicle alter1 driving in front in the middle lane is determined as reference vehicle and on conclusion a switch is then made to the vehicle alter2 driving in front on the slower lane. This respective reference vehicle in the own or in the neighbouring lane is displayed to the driver of the own motor vehicle ego by means of a graphical, optical man-machine interface in the form of a display in the own motor vehicle ego.

By the procedure disclosed here, an anticipatory, automated deceleration of the own vehicle ego with adaptive cruise control ACC for the automatic support of merging manoeuvres to the slower lane is achieved. The “anticipatory” reduction in the vehicle speed of the own vehicle ego with the aid of the adaptive cruise control ACC is executed in this case if a driver desire for a merging manoeuvre/a lane change in the direction of the slower lane is detected and its safe feasibility within the system limits of the own vehicle ego and the environmental situation of the own vehicle ego is given. This leads to a reduction in driver interventions and offers an extended application area of the adaptive cruise control ACC. Ultimately an increase in driving comfort is achieved by this.

The variants of the device described above and their structural and operational aspects serve only for a better understanding of the structure, mode of operation and properties; they do not restrict the disclosure to the exemplary embodiments. The figures are partly schematic, wherein substantial properties and effects are depicted in part clearly enlarged, in order to clarify the functions, active principles, technical configurations and features. Here every mode of operation, every principle, every technical configuration and every feature that is/are disclosed in the figures or in the text can be combined freely and in any way with all claims, every feature in the text and in the other figures, other modes of operation, principles, technical configurations and features that are contained in this disclosure or result from it, so that all conceivable combinations of the procedure described are to be assigned. Even combinations between all individual implementations in the text, meaning in each section of the description, in the claims and even combinations between different variants in the text, in the claims and in the figures are comprised. Nor do the claims limit the disclosure and thus the combination possibilities of all features shown with one another. All disclosed features are also explicitly disclosed here individually and in combination with all other features.

1. A control system which is adapted for use in an own motor vehicle (ego) and intended to identify motor vehicles driving in front, next to and/or behind and preferably objects standing in front, on the basis of environmental data obtained from at least one environmental sensor associated with the own motor vehicle (ego), wherein the at least one environmental sensor is adapted to provide an electronic controller of the control system with the environmental data representing an area in front of, next to and/or behind the own motor vehicle, and wherein the control system is at least adapted and intended to
detect from the environmental data another motor vehicle (alter1, alter2, alter3) participating in traffic in front of the own motor vehicle (ego) as reference vehicle relative to the own motor vehicle (ego) by means of the at least one environmental sensor both on a lane on which the own motor vehicle (ego) is also travelling and on a neighbouring lane with slower traffic than the own motor vehicle (ego), wherein the control system is at least adapted and intended to determine, starting out from a momentary location, the distance and the relative speed with respect to a vehicle driving in front in the slower neighbouring lane,
receive a signal from a man-machine interface in the own motor vehicle (ego) of a driver's desire for a lane change or a request signal for a lane change or for a merging manoeuvre from the route output of a navigation system,
determine whether a lane change is possible within predetermined limits from the distance and the relative speed with respect to the vehicle driving in front in the slower neighbouring lane, and
if this is given, effect a reduction in the driving speed of the own motor vehicle by a braking and/or engine management intervention, in order to enable the driver of the own motor vehicle (ego) to change lane to the slower lane.

2. The control system according to claim 1, in which the man-machine interface in the own motor vehicle (ego) evaluates an indicator switch or an eyelid/pupil recognition, in order to recognise the driver's desire to change lane.

3. The control system according to claim 1, in which the predetermined limits are (i) a maximal deceleration of the own motor vehicle (ego), (ii) a minimal distance of the own motor vehicle (ego) to the vehicle driving in front in the slower lane, and/or (iii) a minimal distance between the vehicle driving in front and a vehicle following this in the slower lane.

4. The control system according to claim 1, which is adapted and intended to recognise via other sensors in the own motor vehicle (ego) the actual initiation of the lane change to the slower lane by means of additional sensor information (such as, for example, steering angle, yaw rate, angle to the lane, lateral position with respect to the vehicle driving in front).

5. The control system according to claim 4, which is adapted and intended to effect the reduction in the driving speed of the own motor vehicle (ego) by a braking and/or engine management intervention to the extent that a predetermined distance to the vehicle driving in front on the slower lane is safely set.

6. The control system according to claim 4, which is adapted and intended to select, according to the situation, optionally the vehicle driving in front in the own or the neighbouring lane as reference vehicle.

7. The control system according to claim 1, which is adapted and intended to display the reference vehicle in the own or in the neighbouring lane to the driver of the own motor vehicle (ego) by means of a graphical, optical man-machine interface of the own motor vehicle (ego).

8. A method for use in an own motor vehicle to identify, based on environmental data, motor vehicles driving in front of, next to and/or behind an own motor vehicle and preferably objects standing in front, to provide the environmental data representing an area in front of, next to and/or behind the own motor vehicle, and wherein the method comprises the steps:
identifying another motor vehicle participating in traffic in front of the own motor vehicle as reference vehicle relative to the own motor vehicle both on a lane on which the own motor vehicle is also travelling and on a neighbouring lane with slower traffic than the own motor vehicle,
starting out from a momentary location, determining the distance and the relative speed with respect to a vehicle driving in front in the slower neighbouring lane,
receiving a signal of a driver's desire for a lane change or a request signal for a lane change or for a merging manoeuvre,
determining whether a lane change is possible within predetermined limits from the distance and the relative speed with respect to the vehicle driving in front in the slower neighbouring lane, and
if this is given, effecting a reduction in the driving speed of the own motor vehicle by a braking and/or engine management intervention, in order to enable the driver of the own motor vehicle to change lane to the slower lane.

9. The method according to claim 8, in which the predetermined limits are (i) a maximal deceleration of the own motor vehicle (ego), (ii) a minimal distance of the own motor vehicle (ego) to the vehicle driving in front in the slower lane, and/or (iii) a minimal distance between the vehicle driving in front and a vehicle following this in the slower lane.
